(19) United States
(12) Patent Application Publication
(10) Pub. No.: US 2017/0363212 A1
(43) Pub. Date: Dec. 21, 2017

(54) ROTATING SEAL AND SEALING ELEMENT THEREFOR

(71) Applicant: General Electric Company, Schenectady, NY (US)

(72) Inventors: Mohamed Musthafa Thoppil, Subang (MY); Bikramjit Chatterjee, State College, PA (US); Sunil Srinvasa Murthy, Bangalore (IN)

(21) Appl. No.: 15/183,309

(22) Filed: Jun. 15, 2016

(51) Int. Cl. F16J 15/447

(52) U.S. Cl. CPC F16J 15/4476

(57) ABSTRACT

A sealing element apparatus for a rotating seal includes an array of cells defining an annular sealing surface, where the cells are divided into a plurality of layers extending parallel to the sealing surface.

### BACKGROUND OF THE INVENTION

This invention relates generally to seals for fluid flow and more particularly to noncontact rotating seals.

Various types of turbomachinery, such as gas turbine engines, aircraft engines, and steam turbines are known and widely used for power generation, propulsion, and the like. The efficiency of the turbomachinery depends in part upon the clearances between the internal components and the leakage of primary and secondary fluids through these clearances. For example, large clearances may be intentionally allowed at certain rotor-stator interfaces to accommodate large, thermally or mechanically-induced, relative motions. Leakage of fluid through these gaps from regions of high pressure to regions of low pressure may result in poor efficiency for the turbomachinery. Such leakage may impact efficiency in that the leaked fluids fail to perform useful work.

Different types of sealing systems are used to minimize the leakage of fluid flowing through turbomachinery. For example, noncontact seals are often incorporated between two rotating elements or a rotating element and a stationary element. One common type of noncontact seal is a so-called “labyrinth seal” which includes a rotor having one or more thin annular flanges often referred to as “seal teeth”.

The labyrinth seal rotor rotates in close proximity to a stationary sealing element. In practical applications the stationary sealing element is usually made “abradable” or sacrificial relative to the seal teeth. In the event that the seal teeth contact the sealing element, any damage will occur preferentially to the sealing element, which is typically less expensive and/or easier to replace than the seal teeth.

One common type of abradable seal is a “honeycomb” seal comprising a cellular structure made from thin sheet material. One problem with existing honeycomb seals is that as clearances become small, bypass flow over the labyrinth seal teeth becomes a significant problem.

### BRIEF SUMMARY OF THE INVENTION

this problem is addressed by the technology described herein, which provides a rotating seal assembly where a sealing element thereof includes layers of cells each having a relatively small radial height.

According to one aspect of the technology described herein, a sealing element apparatus for a rotating seal includes an array of cells defining an annular sealing surface, where the cells are divided into a plurality of layers extending parallel to the sealing surface.

According to another aspect of the technology described herein, a rotating seal apparatus includes: a sealing element comprising an array of cells defining an annular sealing surface, where the cells are divided into a plurality of layers extending parallel to the sealing surface; and a rotor disposed adjacent the sealing surface, the rotor comprising at least one annular seal tooth.

According to another aspect of the technology described herein, a rotating seal apparatus includes: a sealing element comprising a plurality of spaced-apart generally parallel walls, each wall having have a periodic shape comprising a series of peaks and valleys, the walls cooperatively defining an annular sealing surface.

### BRIEF DESCRIPTION OF THE DRAWINGS

The invention may be best understood by reference to the following description taken in conjunction with the accompanying drawing figures, in which:

FIG. 1 is a cross-sectional view of a labyrinth seal apparatus;

FIG. 2 is a plan view of a portion of a sealing element of FIG. 1;

FIG. 3 is a plan view of a portion of an alternative sealing element;

FIG. 4 is a plan view of a portion of an alternative sealing element;

FIG. 5 is a plan view of a portion of an alternative sealing element;

FIG. 6 is a perspective view of a portion of an alternative sealing element in close proximity with a seal tooth; and

FIG. 7 is a perspective view of a portion of the sealing element shown in FIG. 6.

### DETAILED DESCRIPTION OF THE INVENTION

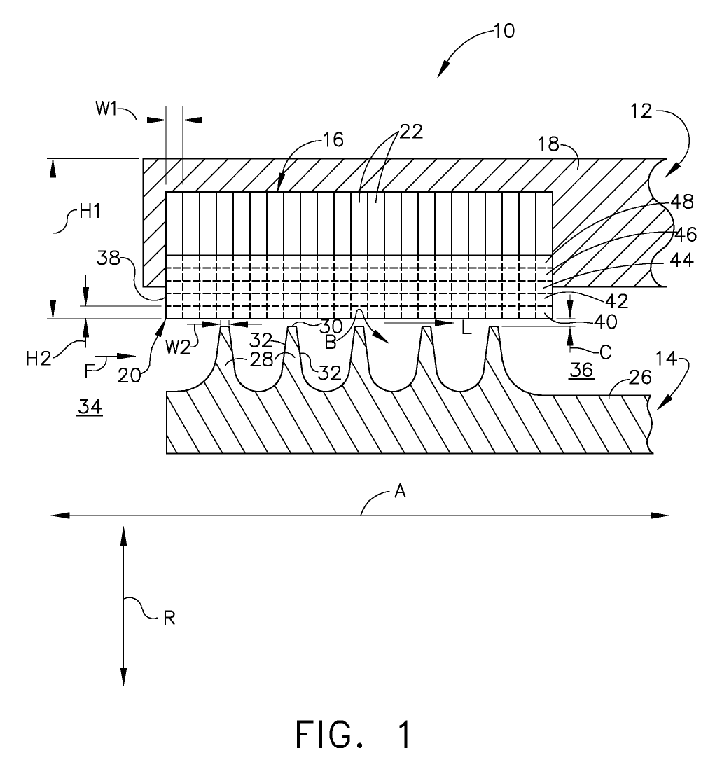

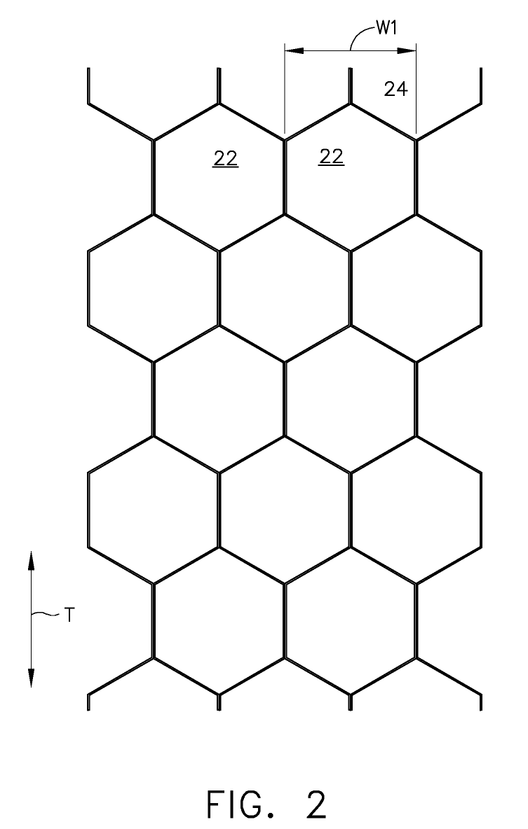

Referring to the drawings wherein identical reference numerals denote the same elements throughout the various views, FIGS. 1 and 2 illustrate an exemplary rotating seal assembly 10 which includes a stator 12 positioned in close proximity to a rotor 14. The stator 12 includes a sealing element 16 carried by a support 18. In the illustrated example, the stator 12 is an annular structure which is positioned radially outboard of the rotor 14, which in turn is mounted for rotation about an axis of rotation “A”. However, it will be appreciated that the rotor 14 could be positioned radially outboard of the stator 12. Furthermore, it is possible that the rotating/stationary relationship of the rotor 14 and the stator 12 could be the inverse of that illustrated, or that both elements could be mounted for rotation.

It is noted that, as used herein, the term “axial” or “longitudinal” refers to a direction parallel to the axis A, while “radial” refers to a direction perpendicular to the axial direction, and “tangential” or “circumferential” refers to a direction mutually perpendicular to the axial and tangential directions. (See arrows “R”, and “T” in FIGS. 1 and 2). These directional terms are used merely for convenience in description and do not require a particular orientation of the structures described thereby

The sealing element 16 is an annular structure defining a sealing surface 20 facing the rotor 14. The sealing element 16 has an overall height “H1” in the radial direction.

As seen in FIGS. 1 and 2, the sealing element 16 comprises an array of cells 22. In the specific example illustrated, the cell array is a honeycomb structure comprising a repeating two-dimensional array of cells 22, where each cell 22 is a regular hexagon defined by walls 24. The walls 24 may be formed from thin sheet material, such as a metal alloy. This type of cellular structure is commonly referred to in the art as a “honeycomb seal”. In the illustrated example, the individual cells 22 have a width “W1” measured in the axial direction (i.e. parallel to the axis A). As a nonlimiting example, the width W1 may be approximately 1.5 mm (60 mils). It is noted that the U.S. customary term “mils” may be used herein to describe linear dimensions, wherein one mil is equal to 1/1000 of an inch.

The rotor 14 includes a body 26 with one or more annular seal teeth 28 extending radially outward therefrom. As used herein, the term “seal tooth” refers to a relatively thin annular structure or flange extending away from a body. In the illustrated example, each seal tooth 28 includes a radially outward facing end face 30 flanked by a pair of tapered side walls 32. The end face 30 has a width “W2” which is selected to suit a particular application. As an example, the width W2 may be about 0.3 mm (10 mils) to about 2.0 mm (80 mils), or about half of the width W1 of the cells 22 of the sealing element 16.

When assembled in an engine, the stator 12 is positioned with the sealing surface 20 thereof in close proximity to the seal teeth 28 of the rotor 14. A radial clearance “C” is present between the sealing surface 20 and the seal teeth 24. The rotating seal assembly 10 is effective to reduce or prevent a leakage flow “F” between a first zone 34 located upstream of the rotating seal assembly 10 and a second zone 36 located downstream of the rotating seal assembly 10.

The sealing element 16 is configured to act as a sacrificial element relative to the rotor 14. Specifically, the material, dimensions, and cell configuration of the sealing element 16 are selected such that, in the event of the rotor 14 contacting the sealing element 16, the rotor 14 can cut into or deform the sealing element 16 without causing damage to the rotor 14. This sacrificial property may be referred to as the sealing element being “abradable”. This abradable property may be used to enhance sealing in multiple ways. For example, a nominal clearance between the sealing element 16 and the rotor 14 may be set very small with the expectation that the rotor 14 will cut into the sealing element 16 during initial operation, resulting effectively in a zero-clearance seal. Alternatively or in addition to this function, the abradable property allows the rotor 14 to temporarily deflect outwards during extreme or unusual operating conditions without permanent damage to itself.

in operation, the leakage flow F is made up of a leakage flow “L” passing through the radial clearance C in an axial direction, as well as a bypass flow “B” flowing in a path up and over the seal tooth 28, into the honeycomb cell 22, back down over the seal tooth 28, and subsequently downstream.

In the prior art it is common for a seal assembly, such as the seal assembly 10 described above to operate with a radial clearance C on the order of about 0.76 mm (30 mils). Under these conditions, bypass flow B is not a significant portion of the leakage flow F.

However, for some applications it is desirable to configure the seal assembly 10 with a smaller radial clearance C in order to minimize the total leakage flow F. For example, the radial clearance C may be about 0.25 mm (10 mils). At such small clearances, the bypass flow B can be significant, for example 50% to 100% of the leakage flow L.

The bypass flow B can be reduced simply by reducing the overall height H1 of the sealing element, with the effect of reducing a height of the cells 22. However, this configuration would have the undesirable side effect of reducing the amount of space available for the seal teeth 28 to cut into the sealing element 16. In some engine operating conditions, this could result in the seal teeth 28 contacting the support 18 and damaging the seal teeth 28.

In order to reduce the bypass flow B while maintaining other desirable characteristics of the sealing element 16, the sealing element may be divided into a plurality of layers. In the example illustrated in FIG. 1, the layers are defined by separators 38 extending transverse to the wall 24. In this example, five separators 38 are shown which define five layers numbered 40, 42, 44, 46, and 48 respectively. the layers 40, 42, 44, 46, and 48 may be described as extending parallel to the sealing surface 20. The number of layers may be varied to suit a particular application. The lowermost layer 40 is open at the sealing surface 20 and thus functions as a conventional honeycomb seal having a very small cell height “H2”. The height H2 may be selected to minimize the bypass flow B. For example, the height H2 may be approximately 0.13 mm to 0.26 mm (5 mils to 10 mils). The remaining layers 42, 44, 46, and 48 are closed off in the initial condition of the sealing element 16.

The small cell height of the exposed layer 40 allows the rotating seal assembly 10 to operate with minimal bypass flow B. Due to the effectively smaller height of the cells 22, the leakage air experiences higher flow resistance inside the cells 22 and hence the discharge coefficient (Cd) of the bypass leakage decreases. Testing has shown that this arrangement is effective to reduce the net leakage flow F through the rotating seal assembly 10.

In the event that the rotor 14 should experience an excursion and cut into the innermost separator 38, the cell height would still be effectively equal to the sum of the heights of the first and second layers 40 and 42.

It is noted that the layers do not need to extend through the entire height H1 of the sealing element 16 in order to provide the benefit of reduced bypass flow B. For example, the total height of all the layers 40, 42, 44, 46, and 48 could be only about one-third of the overall height H1. This arrangement would minimize the number of layers required and thus the complexity of the sealing element 16, while still ensuring that any increase in cell height would be minimized for any degree of abrasion.

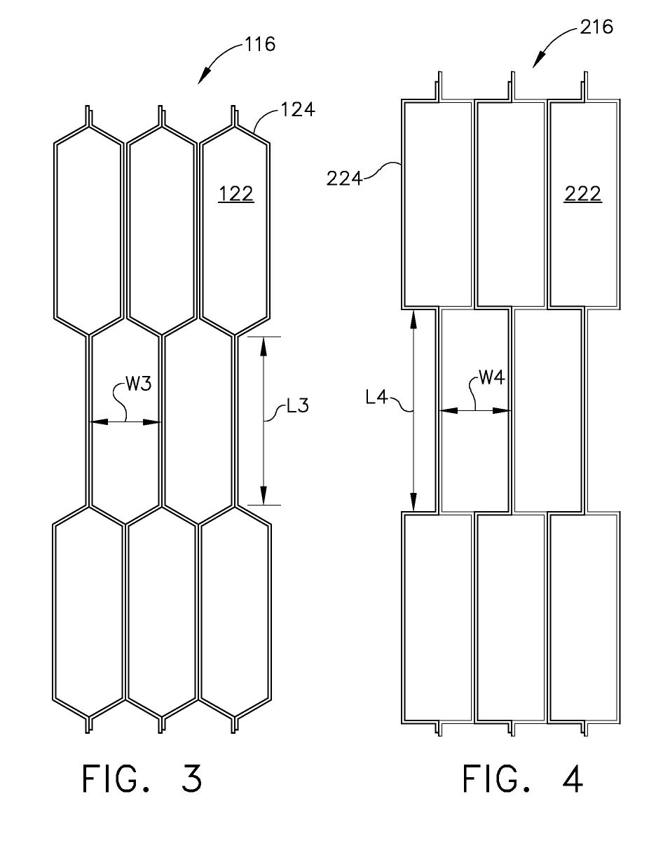

FIG. 3 illustrates an example of an alternative sealing element 116 comprising an array of cells 122. In the specific example illustrated, the cell array is a honeycomb structure comprising a repeating two-dimensional array of cells, where each cell 122 is a hexagon defined by walls 124. The walls 124 may be formed from thin sheet material, such as a metal alloy. In the illustrated example, the individual cells 22 have a width “W3” measured in the axial direction (i.e. parallel to the axis A), as well as a length “L3” measured in the tangential direction (i.e. perpendicular to the axis A). As an example, the width W3 may be significantly smaller than the cell width of a prior art honeycomb seal, for example approximately 0.76 mm (30 mils). Concurrently, the length L3 may be on the order of three times the width W3. It is believed that this configuration is effective to reduce bypass flow as described above, while limiting the total amount of material in the walls 124 so as to minimize heat generation in the case of contact between a seal tooth and the sealing element 116. Thus, the illustrated design is believed to be more effective than simply reducing all dimensions of the cells 122 equally.

The sealing element 116 may be used alone or in conjunction with the layered configuration described above. That is, one or more separators (not shown) may be provided extending transverse to the walls 124 for the purpose of dividing sealing element 116 into two or more layers each having a relatively short height.

FIG. 4 illustrates another alternative sealing element 216 similar in construction to the sealing element 116 described above and comprising an array of cells 222 defined by walls 224. In the illustrated example, the individual cells 222 have a width “W4” measured in the axial direction (i.e. parallel to the axis A), as well as a length “L4” measured in the tangential direction (i.e. perpendicular to the axis A). These dimensions and their relative proportions may be the same as or similar to the respective width and length W3, L3 of sealing element 116 described above. The cells 222 differ from the cells 222 only in that they are rectangular instead of hexagonal.

The sealing element 216 may be used alone or in conjunction with the layered configuration described above. That is, one or more separators (not shown) may be provided extending transverse to the walls 224 for the purpose of dividing sealing element 216 into two or more layers each having a relatively short height.

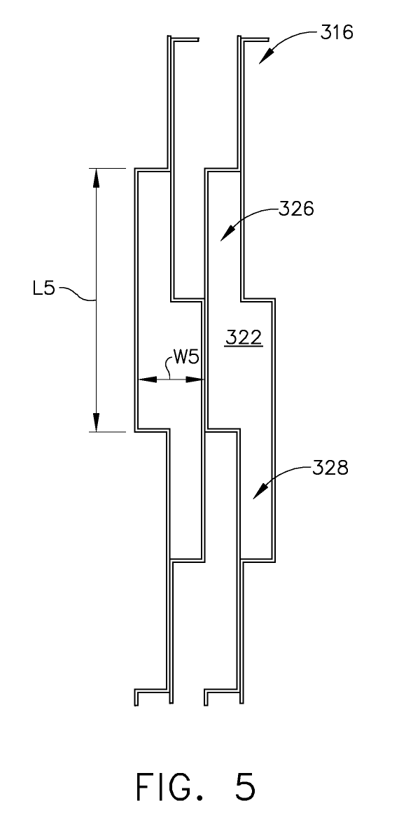

FIG. 5 illustrates another alternative sealing element 316 comprising an array of cells 322. In the specific example illustrated, the cell array comprises a repeating two-dimensional array of cells, where each cell 322 is defined by walls 324. The walls 324 may be formed from thin sheet material, such as a metal alloy. Each cell 322 as a shape which may be described as two rectangular elements 326, 328 respectively merged to form a single shape. The overall shape of the cell 322 may be described as a “staggered rectangle”, a “joggle”, or a shallow “S” shape. In the illustrated example, the individual cells 322 have a width “W5” measured in the axial direction (i.e. parallel to the axis A), as well as a length “L5” measured in the tangential direction (i.e. perpendicular to the axis A). As an example, the width W5 may be significantly smaller than the cell width of a prior art honeycomb seal, for example approximately 0.76 mm (30 mils), or could be approximately the same as a cell width of a prior art honeycomb seal, for example approximately 1.5 mm (60 mils). Concurrently, the length L5 may be on the order of 1 to 3 times the width W3. It is believed that this configuration is effective to reduce bypass flow as described above, while limiting the total amount of material in the walls 324 so as to minimize heat generation in the case of contact between a seal tooth in the sealing element 316.

The sealing element 316 may be used alone or in conjunction with the layered configuration described above. That is, one or more separators (not shown) may be provided extending transverse to the walls 324 for the purpose of dividing sealing element 316 into two or more layers each having a relatively short height.

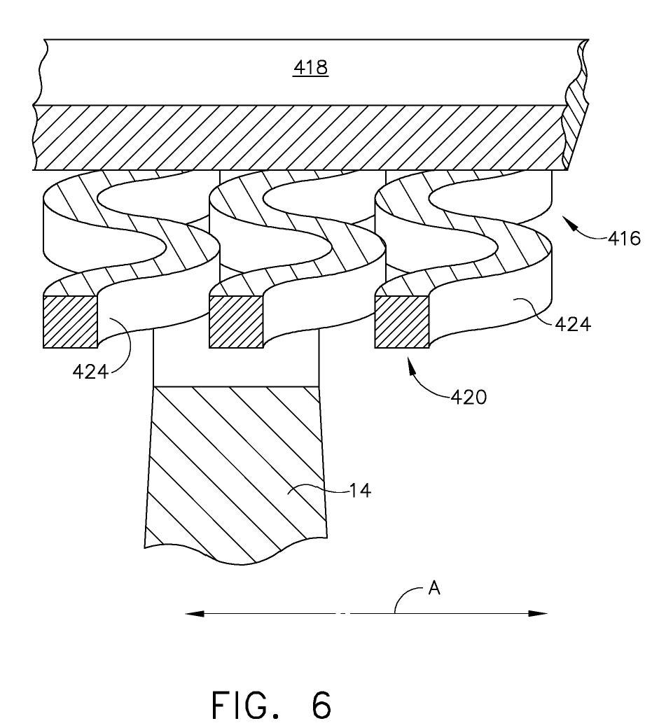

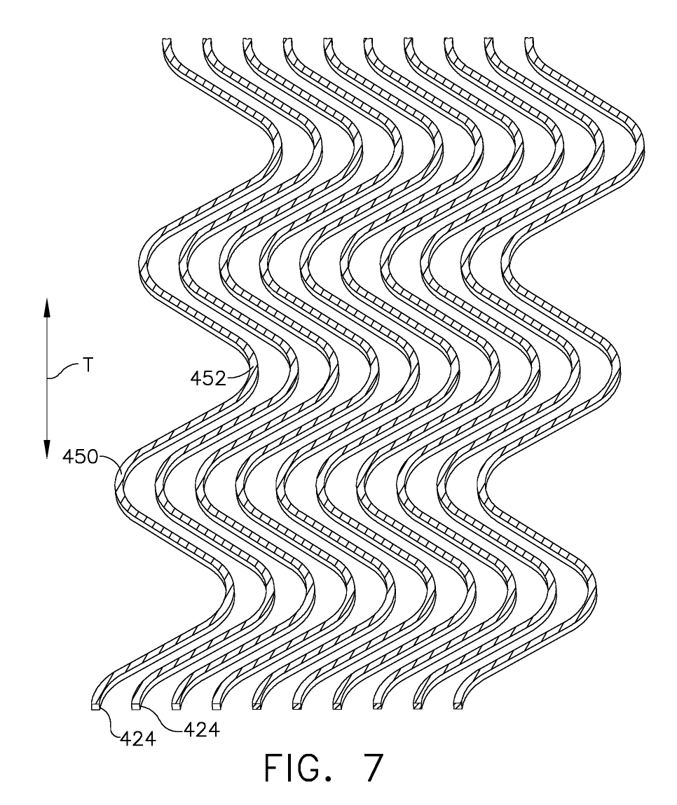

FIGS. 6 and 7 illustrate an example of an alternative sealing element 416. More specifically, the sealing element 416 is an annular structure comprising a plurality of spaced-apart, generally parallel walls 424 abutting a support 418. The walls 424 have a periodic or undulating shape comprising a series of peaks 450 and valleys 452 along a circumferential or tangential direction “T” which is perpendicular to the axis A. This type of shape may also be described as “wavy”. In the illustrated example, the shape comprises smooth curves, however other configurations such as sawtooth or square-wave may be used as well. The walls 424 may be made from an appropriate material such as a metal alloy.

The walls 424 define a sealing surface 420 facing a rotor 14. Similar to the sealing element 16 described above, the sealing element 416 is configured to act as a sacrificial element relative to the rotor 14. Specifically, the material, dimensions, and sell configuration of the sealing element 16 are selected such that, in the event of the rotor 14 contacting the sealing element 16, the rotor 14 can cut into or deform the sealing element 16 without causing damage to the rotor 14. This sacrificial property may be referred to as the sealing element 416 being “abradable”.

The wavy walls 424 of the sealing element 416 may be used alone or in conjunction with the layered configuration described above. That is, one or more separators (not shown) may be provided extending transverse to the walls 424 for the purpose of dividing sealing element 416 into two or more layers each having a relatively short height.

The sealing elements described above have several advantages over the prior art. In particular, they are believed to reduce bypass leakage flow and/or total leakage flow as compared to prior art honeycomb sealing elements, while still providing acceptable abrasion properties.

The foregoing has described a sealing element for a rotating seal. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A sealing element apparatus for a rotating seal, comprising an array of cells defining an annular sealing surface, where the cells are divided into at least three abradable layers extending parallel to the sealing surface.

2. The apparatus of claim 1 wherein the array of cells has an overall height measured in a direction perpendicular to the sealing surface, and a total height of the layers, measured in a direction perpendicular to the sealing surface, is less than the overall height.

3. The apparatus of claim 1 wherein each layer has a height, measured in a direction perpendicular to the sealing surface, in a range of about 5 mils to about 10 mils.

4. The apparatus of claim 1 wherein the cells have a length, measured in a direction parallel to the sealing surface, and a width, measured in a direction parallel to the sealing surface and perpendicular to the width, where the length is greater than the width.

5. The apparatus of claim 4 wherein the width is approximately 30 mils.

6. The apparatus of claim 4 wherein the cells have a hexagonal shape.

7. The apparatus of claim 4 wherein the cells have a rectangular shape.

8. The apparatus of claim 4 wherein the cells have a joggle shape.

9. The apparatus of claim 1 in combination with a rotor disposed adjacent the sealing surface of the sealing element.

10. The apparatus of claim 9 wherein a radial clearance between the sealing surface and the rotor is less than 30 mils.

11. A rotating seal apparatus, comprising:
a sealing element comprising an array of cells defining an annular sealing surface, where the cells are divided into at least three abradable layers extending parallel to the sealing surface; and
a rotor disposed adjacent the sealing surface, the rotor comprising at least one annular seal tooth.

12. The apparatus of claim 11 wherein the sealing element has an overall height, measured in a direction perpendicular to the sealing surface, and a total height of the layers, measured in a direction perpendicular to the sealing surface, is less than the overall height.

13. The apparatus of claim 11 wherein a radial clearance between the sealing surface and the rotor is less than 30 mils.

14. The apparatus of claim 11 wherein each layer has a height, measured in a direction perpendicular to the sealing surface, in a range of about 5 to about 10 mils.

15. A rotating seal apparatus, comprising:
a sealing element comprising a plurality of spaced-apart generally parallel walls, each wall having have a periodic shape comprising a series of peaks and valleys, the walls cooperatively defining an annular sealing surface made of cells divided into at least three abradable layers extending parallel to the sealing surface.

16. The apparatus of claim 15 further comprising a rotor disposed adjacent the sealing surface, the rotor comprising at least one annular seal tooth.

17. The apparatus of claim 16 wherein a radial clearance between the sealing surface and the rotor is less than 30 mils.

18. The apparatus of claim 15 wherein the walls are divided into a plurality of layers extending parallel to the sealing surface.

19. The apparatus of claim 18 wherein the sealing element has an overall height, measured in a direction perpendicular to the sealing surface, and a total height of the layers is less than the overall height.

20. The apparatus of claim 18 wherein each layer has a height, measured in a direction perpendicular to the sealing surface, in a range of about 5 mils to about 10 mils.
